(19) United States
(12) Patent Application Publication
(10) Pub. No.: US 2006/0027512 A1
(43) Pub. Date: Feb. 9, 2006

(54) Methods and apparatus for removing fine particulate contaminants from commercial laundry waste water

(76) Inventor: James P. Sharkey, Calverton, NY (US)

Correspondence Address: Galgano & Burke, Suite 35, 300 Rabro Drive, Hauppauge, NY, 11788, US

(21) Appl. No.: 10/911,832

(22) Filed: Aug. 5, 2004

(51) Int. Cl. B01D 29/62

(52) U.S. Cl. 210/798; 210/805; 210/196; 210/411

(57) ABSTRACT

A waste water filter apparatus includes a filter vessel, a filter, and a pump. The filter vessel acts as a buffer in which waste water enters at the bottom and exits at the top. While the water is in the filter vessel, it is pumped from the bottom by the pump through the filter and back to the top of the filter vessel. According to a preferred embodiment, the waste water is filtered as many as six times before it exits the filter vessel. Should the pump fail, the flow of water through the filter vessel is not impeded in any way. During backwash, water is pumped through the filter in the reverse direction and into the filter vessel above the bottom of the filter vessel and exits the filter vessel below the top. This results in the capture of backwashed filter media in the filter vessel where it will be returned to the filter when the filter mode is next activated. The backwash water exits the filter vessel below the clean water exit into a sludge holding tank.

### RELATED PATENTS

This application is related to co-owned U.S. Pat. Nos. 6,692,638; 6,672,462; 5,575,913; and 5,350,526, the complete disclosures of which are hereby incorporated by reference herein.

### BACKGROUND OF THE INVENTION

1. Field of the Invention

The present invention relates generally to a filtration apparatus for separating solid particles from a liquid. More particularly, the invention relates to a filtration apparatus for removing fine particulate contaminants from commercial laundry waste water and a method for accomplishing the same.

2. Brief Description of the Prior Art

State and local governments across the country as well as the federal government have enacted environmental laws or expanded existing environmental laws to reverse or limit the threat of environmental pollution. These environmental laws are typically directed toward commercial enterprises which create various waste streams as a by-product of manufacturing or providing services. The commercial laundry industry and particularly commercial laundromats are specifically affected by environmental laws which limit the amount of suspended solids or particulate contaminants in commercial laundry waste water which can be discharged into the environment. Particulate contaminants in commercial laundry waste water generally consist of lint, hair, dirt and soap scum. To meet current environmental laws, the amount of particulate contaminants in the commercial laundry waste water must be reduced to an acceptable level before it is discharged into the ground water and/or municipal sewage system.

Separating solid particles, impurities, particulate contaminants, etc. from a liquid or gas is generally accomplished by passing it through a porous substance or a filter. For example, U.S. Pat. No. 4,322,293 granted to Morgan, Jr. discloses a multiple element filter having a housing which supports and suspends a number of filter elements, e.g., screen or cloth or other similar interwoven filtering material, which have open upper ends which accept a liquid to be filtered. However, once the filter elements become clogged or full, the housing must be opened and the filter elements removed and cleaned or replaced.

A number of devices for filtering or separating solid particles, impurities, particulate contaminants, etc. from a liquid include a filter or filter elements and also means for imparting motion to the filter elements to aid in the filtering or separating process and/or removal of separated contaminants from the surface of the filter elements. One example, is U.S. Pat. No. 2,480,320 granted to Carrier which discloses a filter apparatus for removing impurities from cleaning fluids used in dry cleaning clothing. The filter apparatus includes a casing having a plurality of individual filter elements which are vertically supported in spaced relation to each other and in such a way that they can be oscillated in the casing as a unit while in the cleaning liquid to remove sludge from the filter elements whereupon it will drop into the lower portion of the casing below an outlet pipe. At frequent intervals the sludge can be removed through a sludge outlet.

Another example is U.S. Pat. No. 4,289,630 granted to Schmidt, Jr. et al. which discloses a filtration apparatus having a plurality of filter elements supported between an upper inlet manifold and a lower outlet manifold. The filter apparatus also includes means for cleaning the filter element after a filter cake has been deposited thereon. Specifically, a vibratory impactor is mounted on upper inlet manifold to impart vertically directed shock waves to the manifold and to the filter elements connected thereto to dislodge the filter cakes.

Still another example is co-owned U.S. Pat. No. 5,350,526 granted to Sharkey, et al. which discloses a filtration apparatus for removing particulate contaminants from commercial laundry waste water in which the apparatus has at least one porous mesh-like filter bag coupled between an upper inlet manifold for receiving waste water containing particulate contaminants and a lower outlet manifold for discharging the particulate contaminants separated from the waste water. The filtration apparatus also includes a paddle for agitating the filter bag so as to prevent the mesh-like material of the filter bag from becoming clogged.

A filtration device which has a filtering medium and incorporates both hydraulic and mechanical forces during the process of removing accumulated particulate contaminants is U.S. Pat. No. 3,557,955 granted to Hirs, et al. Hirs, et al. discloses a filtration apparatus for removal or relatively small particulate contaminants in which the filtration apparatus includes a filtering medium of finely divided particulate material, e.g., polyvinyl chloride, polyethylene or wood sawdust. Following filtration, the filter medium is back washed. In addition to the hydraulic forces caused due to back washing, agitators located within the filter medium are rotated to apply mechanical forces during back washing to aid in removal of the accumulated particulate contaminants.

Thus, for satisfying the laundry industry, there is a need for a filtration apparatus that is capable of accepting a relatively large flow of laundry water, capable of removing the relatively small suspended particulate contaminants, and capable of continuous automated operation.

Co-owned U.S. Pat. No. 5,575,913 discloses a filtration apparatus having a housing, a filter element, an inlet, a first discharge outlet and a second discharge outlet. The housing includes a bottom and an upwardly extending surrounding wall. The filter element is disposed in the housing and spans the surrounding wall with the filter element spaced above the bottom of the housing to define an upper chamber and a lower chamber, and the filter element being angled, preferably 45 degrees from the horizontal, so that one end of the filter element is lower relative to the other end. The inlet is in fluid communication with the upper chamber for receiving waste water containing particulate contaminants. A first discharge outlet is in fluid communication with the lower chamber for discharging filtered waste water. The second discharge outlet is in fluid communication with the upper chamber adjacent the lower end of the filter element for discharging filtered particulate contaminants. The apparatus is capable of trapping particles about 50 microns in diameter (or smaller, i.e. 5-10 microns).

Co-owned U.S. Pat. No. 6,672,462 discloses a filtration apparatus which includes a filter element disposed at a 45 degree angle defining an upper chamber for solids and a lower chamber for liquid. A trough is disposed at the lower end of the filter element. The floor of the trough funnels toward a central drain and an overflow drain is located approximately 8 inches above the trough floor. The lower chamber is provided with a drain for re-circulating water to a sprayer above the filter element and is also provided with an overflow drain approximately 8 inches above the floor.

While the co-owned patents describe many advances over the prior art, there are still many disadvantages to current commercial laundry waste water filters. The present invention addresses three problems present in current commercial laundry waste water filters. First, it is a disadvantage that filter media is often lost during backwashing. Second, it is a disadvantage that when a pump fails, flow of waste water through a filter system is impeded. Third, repeated filter stages require more equipment and more commercial floor space.

### SUMMARY OF THE INVENTION

It is therefore an object of the invention to provide an improved filtration apparatus and method for separating and removing particulate contaminants from a relatively large continuous flow of waste water for discharge of the filtered waste water into the environment, i.e., ground water and/or municipal sewage system.

It is also an object of the invention to provide an improved filtration apparatus and method for separating and removing particulate contaminants from a relatively large continuous flow of laundry waste water for discharge of the filtered waste water into the environment in which little or no filter media is lost during backwash.

It is another object of the invention to provide an improved filtration apparatus and method for separating and removing particulate contaminants from a relatively large continuous flow of laundry waste water for discharge of the filtered waste water into the environment in which water flow is not impeded when a filter pump fails.

It is yet another object of the invention to provide an improved filtration apparatus and method for separating and removing particulate contaminants from a relatively large continuous flow of laundry waste water for discharge of the filtered waste water into the environment in which the water is filtered multiple times through a single apparatus.

In accord with these objects which will be discussed in detail below, the filter apparatus according to the invention includes a filter vessel, a filter element, and a pump. The filter vessel acts as a buffer in which waste water enters at the bottom and exits at the top. While the water is in the filter vessel, it is pumped from the bottom by the pump through the filter element and back to the top of the filter vessel. According to an illustrative embodiment, the waste water is filtered as many as six times or more before it exits the filter vessel. Should the pump fail, the flow of water through the filter vessel is not impeded in any way. During backwash, water is fed under pressure through the filter element in the reverse direction and into the filter vessel above the bottom of the filter vessel and exits the filter vessel preferably below the top. This results in the capture of backwashed filter media in the filter vessel where it will be returned to the filter element when the filter mode is next activated. The backwash water exits the filter vessel below the clean water exit into a sludge holding tank.

Certain of the foregoing and related objects are readily attained according to the present invention by the provisions of a waste water filter system, comprising a filter vessel having a waste water inlet, a filtered water inlet, a dirty water outlet, and a clean water outlet, a pump having an inlet and an outlet, said inlet coupled to said dirty water outlet; a filter having a housing containing filter media and having an inlet and an outlet, said inlet being coupled to said outlet of said pump and said outlet being coupled to said filtered water inlet, wherein said pump is operated at a predetermined flow rate relative to the flow rate of waste water flow through said filter vessel such that waste water entering said filter vessel through said waste water inlet is re-circulated through said filter more than once before exiting said clean water outlet.

Preferably, the waste water entering said filter vessel through said waste water inlet is re-circulated through said filter element four to six times before exiting said clean water outlet. Most desirably said filter vessel is dimensioned to hold approximately thirty gallons, said pump has a pump flow rate of approximately thirty gallons per minute, said filter is capable of capturing particles approximately 0.01-15. microns in size, and waste water flows through said filter vessel at a rate of approximately five gallons per minute. Most advantageously, said waste water inlet is near the bottom of said filter vessel, said filtered water inlet is near the top of said filter vessel, said dirty water outlet is below said waste water inlet, and said clean water outlet is above said filtered water inlet.

In a preferred embodiment of the invention, a waste water filter system is provided comprising a filter vessel having a waste water inlet, a filtered water inlet, a backwash inlet, a dirty water outlet, a backwash outlet, and a clean water outlet; a pump having an inlet and an outlet; a filter having an inlet and an outlet; a pump bypass having an inlet and outlet for connecting said filter inlet to said backwash inlet; and valve means for selectively and alternately engaging said pump and said pump bypass. During a filter mode, said valve means engages said pump and couples said pump inlet to said dirty water outlet and said filter inlet to said pump outlet, and said filter outlet is coupled to said filtered water inlet so that waste water entering said filter vessel through said waste water inlet is re-circulated through said filter more than once before exiting said clean water outlet. During a backwash mode, said valve means engages said pump bypass which couples said filter inlet to said backwash inlet, so that filter media removed from said filter during backwash is captured by said filter vessel without passing through said backwash outlet.

Preferably, the backwash inlet is above said waste water inlet but below said filtered water inlet and said backwash outlet is above said backwash inlet but below said clean water outlet. Desirably, the system additionally including a source of pressurized backwash water coupled to said filter outlet.

Certain of the foregoing and related objects are also attained in a method of filtering waste water comprising the steps of delivering waste water to the bottom of a filter vessel, and removing the waste water from the top of the filter vessel while simultaneously circulating the waste water from the filter vessel through a filter and returning it to the filter vessel so that the water is filtered more than once before it leaves the filter vessel.

The method preferably comprises the further step of backwashing the filter with water fed through it in the reverse of the filtering path into the bottom of the filter vessel and out from the top of the filter vessel so that filter media removed from the filter during backwash is captured in the filter vessel.

In a particularly preferred embodiment of the invention, a waste water filter system is provided comprising a filter vessel having a waste water inlet, a filtered water inlet, a backwash inlet, a dirty water outlet, a backwash outlet, and a clean water outlet, a pump having an inlet and an outlet; and said inlet being selectively coupled to said dirty water outlet and said outlet being selectively coupled to said backwash inlet, and a filter having an inlet and an outlet. During a filter mode, said filter inlet being selectively coupled to said inlet and outlet of said pump and said filter outlet being selectively coupled to said filtered water inlet and said backwash inlet, wherein said pump inlet is coupled to said dirty water outlet and said filter inlet is coupled to said pump outlet, and said filter outlet is coupled to said filtered water inlet, waste water entering said filter vessel through said waste water inlet is re-circulated through said filter element more than once before exiting said clean water outlet. During a backwash mode, in which said pump inlet is coupled to a source of pressurized backwash water, said pump outlet is coupled to said filter outlet, and said filter inlet is coupled to said backwash inlet, filter media removed from said filter during backwash is captured by said filter vessel without passing through said backwash outlet.

### BRIEF DESCRIPTION OF THE DRAWINGS

FIG. 1 is a schematic view of an apparatus according to the invention in a natural flow mode, without the pump activated, with water flowing through the filter vessel;

FIG. 2 is a view similar to FIG. 1 showing the pump activated in filter mode with water stagnant in the filter vessel;

FIG. 3 is a view similar to FIGS. 1 and 2 with the pump activated in filter mode and with water flowing through the filter vessel;

FIG. 4 is a view similar to FIGS. 1-3 in backwash mode with the pump deactivated; and

FIG. 5 is a view similar to FIGS. 2 and 3 but showing a preferred manifold embodiment.

### DETAILED DESCRIPTION OF THE PREFERRED EMBODIMENTS

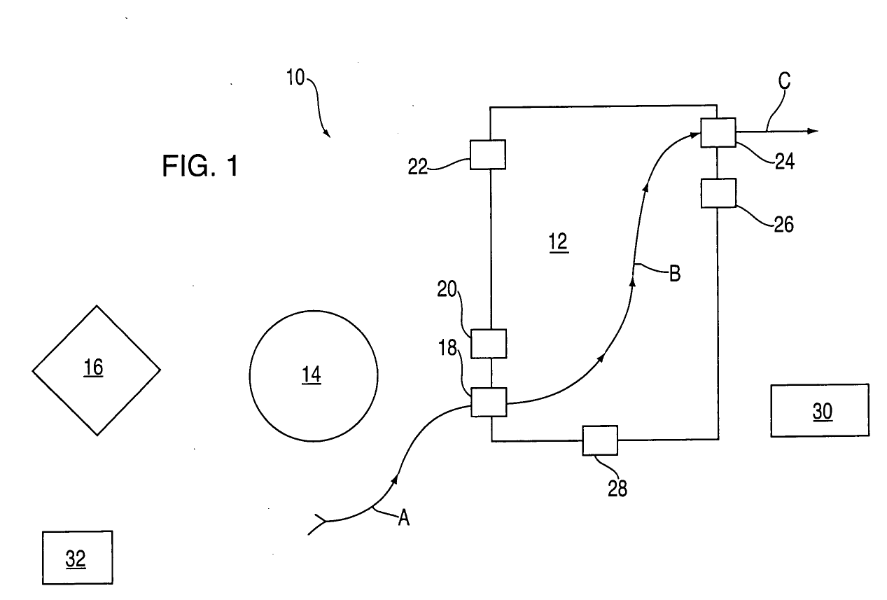

Turning now to FIG. 1, a filter apparatus 10 according to the invention includes a filter vessel 12, a pump 14, and a conventional filter 16 which preferably contains particulate filter media, such as, e.g., sand, charcoal, zeolite and/or other suitable filter media. The filter vessel 12 preferably has three water inlets or ports 18, 20, 22 and three water outlets or ports 24, 26, 28. The water inlets include a waste water inlet 18, backwash inlet 20, and a filtered water inlet 22. The water outlets include a clean water outlet 24, a backwash outlet 26, and a dirty water outlet 28. The waste water inlet 18 is near but not at the bottom of the filter vessel 12. The backwash inlet 20 is preferably slightly above the waste water inlet 18. The filtered water inlet 22 is preferably near the top of the filter vessel 12, above the backwash outlet 26, but below the clean water outlet 24. The clean water outlet 24 is preferably the highest outlet. The backwash outlet 26 is preferably below both the clean water outlet 24 and the filtered water inlet 22. The dirty water outlet 28 is preferably at the very bottom of the filter vessel 12, below all of the other inlets and outlets. The filter vessel 12 is preferably cylindrical, but can be, e.g., rectilinear. The apparatus also preferably includes a sludge holding tank 30 and a pressurized source of backwash water 32 (fed via standard pipe pressure of 40 psi or via a pump).

Normal water flow is illustrated by the flow lines A, B and C in FIG. 1. A flow A of waste water (such as from a commercial laundry waste water stream) enters through the waste water inlet 18 near the bottom of the vessel 12 and the flow B rises to and flows through the clean water outlet 24 near the top of the vessel 12 where it emerges as flow C. This flow path will result in heavy particles dropping to the bottom of the vessel 12 via gravity.

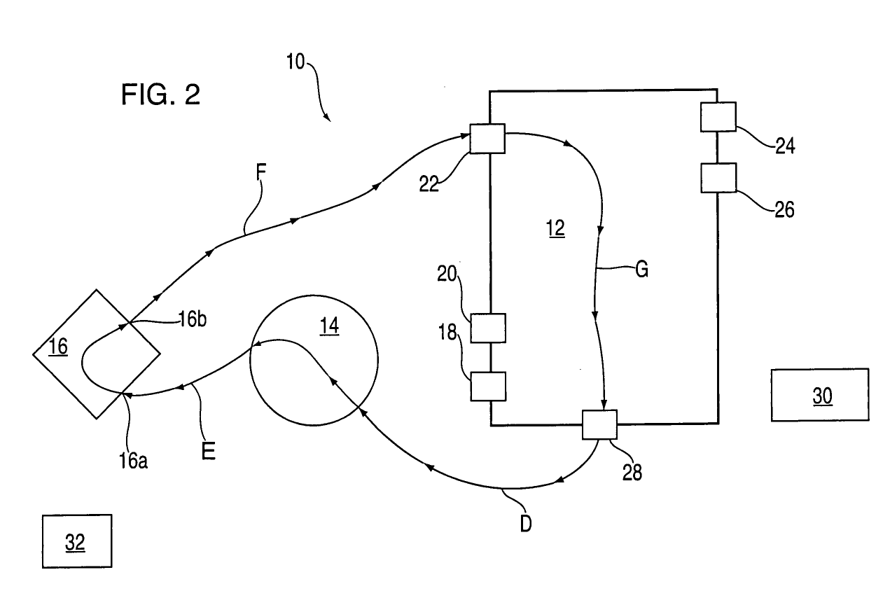

FIG. 2 illustrates the flow of water from the filter vessel 12 through the pump 14 and the filter 16 back to the filter vessel 12. In particular, water flow D exits the filter vessel 12 from the bottom dirty water outlet 28. The pump 14 draws in water flow D and pumps the water flow E into the inlet 16a of the filter 16. The water flow F exits the outlet 16b of the filter 16 and is fed to filtered water inlet 22, flow G re-enters the filter vessel 12 through the filtered water inlet 22 near the top of the filter vessel 12. As illustrated, the inlet 22 is below the clean water outlet 24 and above the backwash outlet 26. Moreover, it should be noted that in a commercial filter (as opposed to the schematically illustrated filter 16) inlet 16a is typically located above outlet 16b.

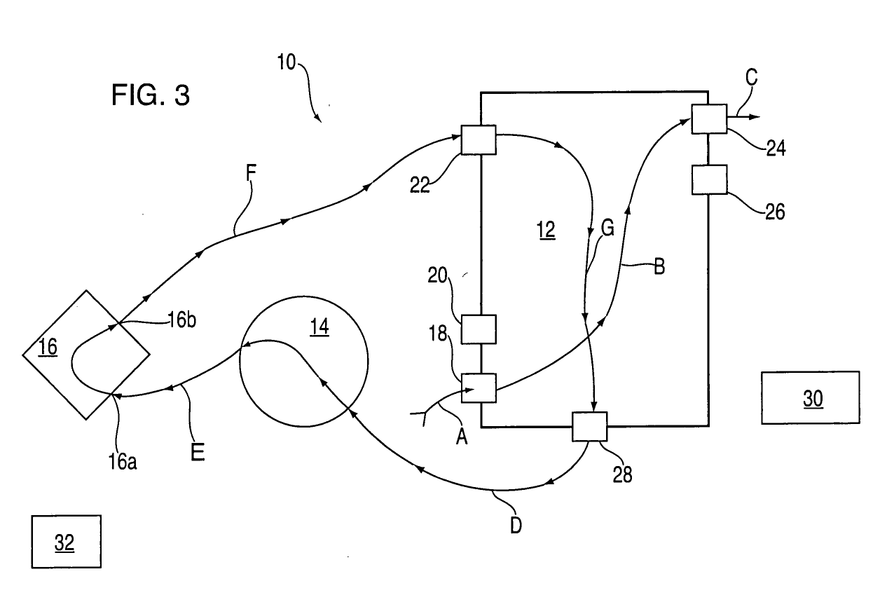

Normal operation of the apparatus 10 is illustrated in FIG. 3 where waste water flows through the filter vessel 12 while simultaneously being filtered by the pump 14 and the filter 16.

As shown in FIG. 3, waste water flow A enters through the waste water inlet 18 near the bottom of the vessel 12 and flow B rises to exit through the clean water outlet 24 near the top of the vessel 12 to produce flow C which contains clean filtered water. This action alone results in some heavy particles dropping to the bottom of the vessel 12 as noted above.

Simultaneously, water flow D exits the filter vessel 12 from the bottom dirty water outlet 28. The pump 14 draws in water flow D and pumps the emerging water flow E into the inlet 16a of the filter 16. The filtered water flow F exits the outlet 16b of the filter 16 and re-enters the filter vessel 12 through the filtered water inlet 22 near the top of the filter vessel 12 to produce filtered water flow G. As illustrated, the inlet 22 is below the clean water outlet 24 and above the backwash outlet 26. According to the presently preferred embodiment, water entering the filter vessel 12 through the waste water inlet 18 is filtered by the pump 14 and filter 16 at least two and preferably four to six times, before exiting the filter vessel 12 through the clean water outlet 24. This is effected by operating the pump 14 at a predetermined flow rate relative to the normal flow of waste water through the filter vessel 12 (an example of which is given below).

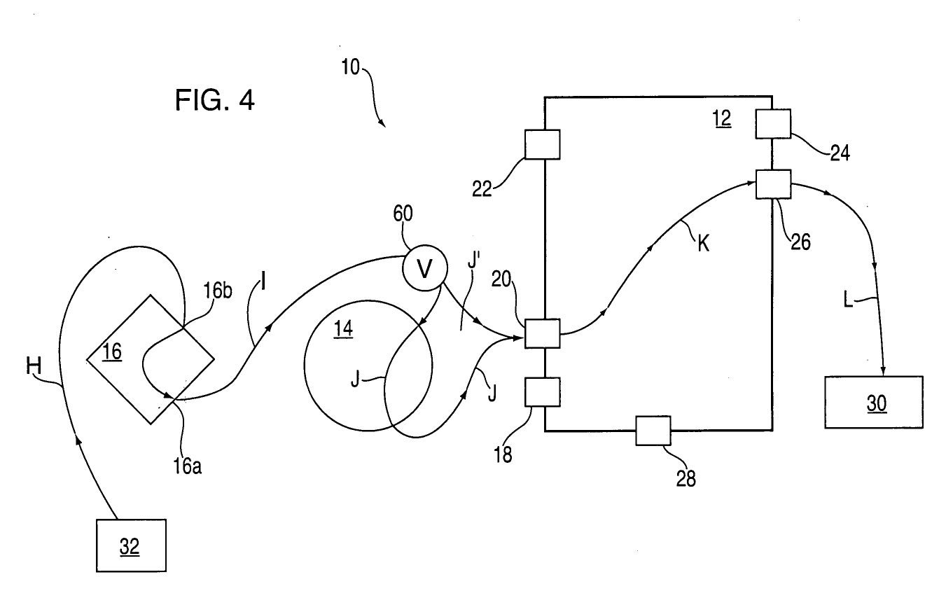

Backwash mode is illustrated in FIG. 4. During backwash, a pressurized source 32 of backwash water H is coupled to the outlet 16b of the filter 16. During backwash, it is not necessary to operate the pump 14 and the pressurized flow I generated by the pressurized source 32 (e.g., water from a conventional source such as a municipal water supply pipe having a pressure of 40 psi or via a pump (not shown)) can bypass pump 14 via a valve 60 or it can possibly pass through pump 14 in a reverse direction (perhaps through an internal bypass) when it is not activated. In either event, the water flow J or J′ containing water with filter media particles, contaminants and sludge previously captured by the filter 16 is fed under pressure into the filter vessel 12 via the backwash inlet 20. The flow stream comprised of filter media, contaminants and sludge fills the filter vessel 12 until it reaches the backwash outlet 26 where flow L containing sludge and lighter contaminant particles flows into a sludge holding tank 30. As illustrated, the backwash inlet 20 is higher than the normal inlet 18. This allows room for virtually all of the relatively heavy filter media (99% or greater) in flow K to drop via gravity to the bottom of the filter vessel 12 where it will be returned to the filter 16 via the outlet 28 when the filter mode is again activated. The backwash outlet 26 is located below the clean water outlet 24 so that no contaminants enter the clean water exit.

According to the presently preferred embodiment, the filter vessel 12 holds approximately thirty gallons and the pump 14 has a pumping rate of approximately thirty gallons per minute. Waste water flow from the inlet 18 to the outlet 24 is preferably at the rate of approximately five gallons per minute. The filter media used in the filter 16 is preferably capable of trapping particles of at least 5-10 microns in size and, preferably, 0.01-15 microns in size.

The methods of the invention include delivering waste water to the bottom of a filter vessel and removing it from the top of the filter vessel while simultaneously circulating the water from the filter vessel through a filter element and returning it to the filter vessel with the aid of a pump so that the water is filtered more than once before it leaves the filter vessel. The methods of the invention further include backwashing the filter element with water fed under pressure in the reverse of the filtering path into the bottom of the filter vessel and out from the top of the filter vessel so that filter media removed from the filter element during backwash is captured in the filter vessel.

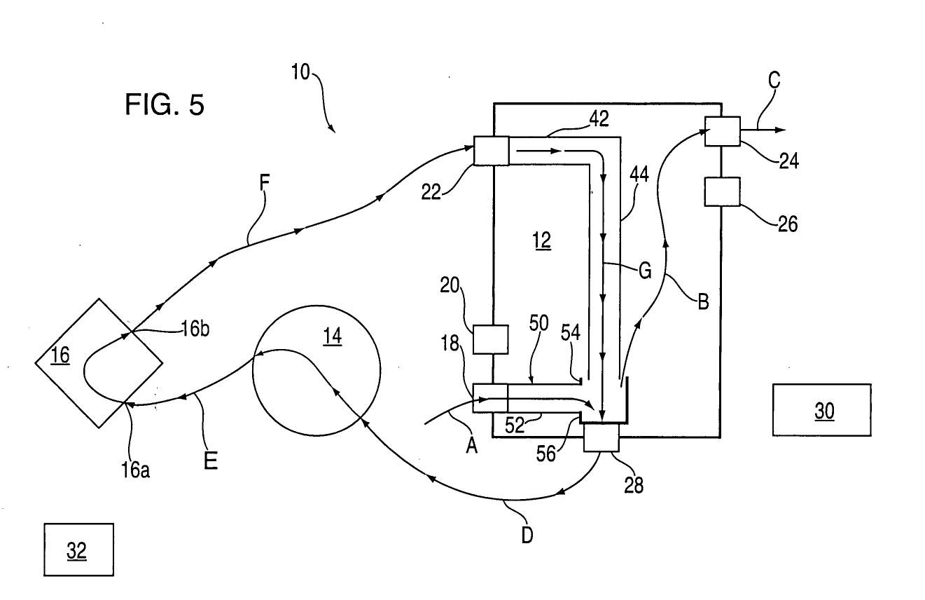

FIG. 5 illustrates a preferred embodiment of the invention which further improves the effectiveness of the unit's filtration ability. This embodiment is the same as that previously illustrated except for the provision of a manifold system which includes a generally L-shaped pipe 40 having a generally horizontally arranged upper leg 42 extending from filtered water inlet 22 and a generally vertically arranged lower leg 44 having an upper end in communication with leg 42 and a lower end which is disposed within a relatively wide mouth or port of a leg 54 of a generally T-shaped pipe 50. T-shaped pipe 50 has a horizontally arranged longer leg 52 which at one end is coupled to waste water inlet 18 and its opposite end communicates and mergers with its vertically arranged upper leg 54 and lower leg 56, the latter of which communicates with, and is coupled to, dirty water outlet 28.

As a result of this construction, waste water flow A will enter dirty water outlet 18 (preferably a 2 inch dia. outlet pipe connected to a 2 inch diameter leg 52 of the preferably 3″×3″×2″ diameter T-shaped pipe 50) at a preferred flow rate of 5 gallons per minute (GPM) and will be drawn into T-shaped pipe 50 so that it will be incorporated into the flow loop (recirculating at approximately 35 GPM) involving flows D, E, or E′, F, and G.

The pipe 42 is preferably a 2″ diameter pipe and pipe leg 44 is inserted about 1 inch into the top of the mouth of the 3 inch diameter upper leg 54 of T-shaped pipe 50.

Excess treated water will be allowed to flow from the mouth of leg 54 of T-shaped pipe 50 into chamber 12 and will flow out of clean water outlet 24 (flow B out to flow C).

The benefits of this manifold system are:

1. It ensures that at least virtually all of the unfiltered waste water (99% or greater) is incorporated into the “loop” system involving the filter, resulting in at least 2 full passes through the filter, and preferably more like 4 to 6 passes before existing the loop system.

2. The “forward” pressure from the flow G and the suction of flow D enables the water stream to move at a faster and less restricted speed. This will enhance the amount of times the unfiltered waste water in the loop system can pass through the filter, thus resulting in cleaner water. It is a known fact that multiple passes through a filter will result in more particulates being removed from the waste water with each pass.

There have been described and illustrated herein methods and apparatus for methods and apparatus for removing fine particulate contaminants especially for commercial laundry waste water. While particular embodiments of the invention have been described, it is not intended that the invention be limited thereto, as it is intended that the invention be as broad in scope as the art will allow and that the specification be read likewise.

For example, although the filter system is especially intended and useful for commercial laundry waste water, it may be useful in dealing generally with separating solids from a liquid and, in particular, with other waste water, dirty water or dirty aqueous streams which collectively and generally are defined herein as “waste water” or “waste water streams”. Furthermore, the dimensions, of the components and piping, the flow rates, water pressure, filter media employed, etc. can be varied to accommodate the particular application intended.

It will therefore be appreciated by those skilled in the art that yet other modifications could be made to the provided invention without deviating from its spirit and scope as so claimed.

What is claimed is:

1. A waste water filter system, comprising:
a filter vessel having a waste water inlet, a filtered water inlet, a dirty water outlet, and a clean water outlet;
a pump having an inlet and an outlet, said inlet coupled to said dirty water outlet;
a filter having a housing containing filter media and having an inlet and an outlet, said inlet being coupled to said outlet of said pump and said outlet being coupled to said filtered water inlet, wherein said pump is operated at a predetermined flow rate relative to the flow rate of waste water flow through said filter vessel such that waste water entering said filter vessel through said waste water inlet is re-circulated through said filter more than once before exiting said clean water outlet.

2. The system according to claim 1, wherein:
waste water entering said filter vessel through said waste water inlet is re-circulated through said filter element four to six times before exiting said clean water outlet.

3. The system according to claim 1, wherein:
said filter vessel is dimensioned to hold approximately thirty gallons, and
said pump has a pump flow rate of approximately thirty gallons per minute.

4. The system according to claim 1, wherein:
said filter is capable of capturing particles approximately 0.01-15. microns in size.

5. The system according to claim 3, wherein:
waste water flows through said filter vessel at a rate of approximately five gallons per minute.

6. The system according to claim 1, wherein:
said waste water inlet is near the bottom of said filter vessel, said filtered water inlet is near the top of said filter vessel, said dirty water outlet is below said waste water inlet, and said clean water outlet is above said filtered water inlet.

7. A waste water filter system, comprising:
a filter vessel having a waste water inlet, a filtered water inlet, a backwash inlet, a dirty water outlet, a backwash outlet, and a clean water outlet;
a pump having an inlet and an outlet;
a filter having an inlet and an outlet;
a pump bypass having an inlet and outlet for connecting said filter inlet to said backwash inlet;
valve means for selectively and alternately engaging said pump and said pump bypass wherein
during a filter mode, said valve means engages said pump and couples said pump inlet to said dirty water outlet and said filter inlet to said pump outlet, and said filter outlet is coupled to said filtered water inlet so that waste water entering said filter vessel through said waste water inlet is re-circulated through said filter more than once before exiting said clean water outlet; and
during a backwash mode, said valve means engages said pump bypass which couples said filter inlet to said backwash inlet, so that filter media removed from said filter during backwash is captured by said filter vessel without passing through said backwash outlet.

8. The system according to claim 7, wherein:
waste water entering said filter vessel through said waste water inlet is re-circulated through said filter element four to six times before exiting said clean water outlet.

9. The system according to claim 7, wherein:
said filter vessel is approximately thirty gallons, and
said pump has a pumping rate of approximately thirty gallons per minute.

10. The system according to claim 7, wherein:
said filter element is capable of capturing particles approximately 0.01-15 microns in size.

11. The system according to claim 9, wherein:
waste water flows through said filter vessel at a rate of approximately five gallons per minute.

12. The system according to claim 7, wherein:
said waste water inlet is near the bottom of said filter vessel, said filtered water inlet is near the top of said filter vessel, said dirty water outlet is below said waste water inlet, and said clean water outlet is above said filtered water inlet.

13. The system according to claim 12, wherein:
said backwash inlet is above said waste water inlet but below said filtered water inlet; and
said backwash outlet is above said backwash inlet but below said clean water outlet.

14. The system according to claim 7, additionally including a source of pressurized backwash water coupled to said filter outlet.

15. A method of filtering waste water, comprising the steps of:
delivering waste water to the bottom of a filter vessel;
removing the waste water from the top of the filter vessel while simultaneously circulating the waste water from the filter vessel through a filter and returning it to the filter vessel so that the water is filtered more than once before it leaves the filter vessel.

16. The method according to claim 1 5, further comprising the steps of:
backwashing the filter with water fed through it in the reverse of the filtering path into the bottom of the filter vessel and out from the top of the filter vessel so that filter media removed from the filter during backwash is captured in the filter vessel.

17. A waste water filter system, comprising:
a filter vessel having a waste water inlet, a filtered water inlet, a backwash inlet, a dirty water outlet, a backwash outlet, and a clean water outlet;
a pump having an inlet and an outlet; and said inlet being selectively coupled to said dirty water outlet and said outlet being selectively coupled to said backwash inlet;
a filter having an inlet and an outlet; wherein
during a filter mode, said filter inlet being selectively coupled to said inlet and outlet of said pump and said filter outlet being selectively coupled to said filtered water inlet and said backwash inlet, wherein said pump inlet is coupled to said dirty water outlet and said filter inlet is coupled to said pump outlet, and said filter outlet is coupled to said filtered water inlet, waste water entering said filter vessel through said waste water inlet is re-circulated through said filter element more than once before exiting said clean water outlet; and
during a backwash mode, in which said pump inlet is coupled to a source of pressurized backwash water, said pump outlet is coupled to said filter outlet, and said filter inlet is coupled to said backwash inlet, filter media removed from said filter during backwash is captured by said filter vessel without passing through said backwash outlet.

18. The system according to claim 1 7, wherein:
waste water entering said filter vessel through said waste water inlet is re-circulated through said filter four to six times before exiting said clean water outlet.

19. The system according to claim 17, wherein:
said filter vessel is dimensioned to hold approximately thirty gallons, and
said pump has a pumping rate of approximately thirty gallons per minute.

20. The system according to claim 17, wherein:
said filter is capable of capturing particles approximately 0.01-15 microns in size.

21. The system according to claim 17, wherein:
said waste water inlet is near the bottom of said filter vessel, said filtered water inlet is near the top of said filter vessel, said dirty water outlet is below said waste water inlet, and said clean water outlet is above said filtered water inlet.

22. The system according to claim 21, wherein:
said backwash inlet is above said waste water inlet but below said filtered water inlet; and
said backwash outlet is above said backwash inlet but below said clean water outlet.
